(19) United States
(12) Patent Application Publication
(10) Pub. No.: US 2026/0163856 A1
(43) Pub. Date: Jun. 11, 2026

(54) METHOD AND SYSTEM FOR PROTECTING AGAINST POTENTIALLY HARMFUL OR FRAUDULENT EMAILS

(71) Applicant: Franz Haimer Maschinenbau KG, Hollenbach-Igenhausen (DE)

(72) Inventor: Andreas Haimer, Hollenbach-Igenhausen (DE)

(21) Appl. No.: 19/414,607

(22) Filed: Dec. 10, 2025

(30) Foreign Application Priority Data
Dec. 10, 2024 (DE) 10 2024 137 014.9

(51) Int. Cl. H04L 51/212; H04L 51/216; H04L 51/224

(52) U.S. Cl. CPC H04L 51/212; H04L 51/216; H04L 51/224

(57) ABSTRACT

A method for protecting against potentially harmful or fraudulent emails. In the method, an incoming email is checked to see whether it is a reply to an email that was previously sent by the recipient. If the incoming email is classified as a reply email, the recipient of the sent email and the sender of the incoming email are compared. If the incoming email is not classified as a reply email, the sender of the incoming email is subjected to an inventory audit. There is also described a corresponding system that carries out the method.

### CROSS-REFERENCE TO RELATED APPLICATION

This application claims the priority, under 35 U.S.C. § 119, of German Patent Application DE 10 2024 137 014.9, filed Dec. 10, 2024; the prior application is herewith incorporated by reference in its entirety.

### FIELD AND BACKGROUND OF THE INVENTION

The invention relates to a method for protecting against potentially harmful or fraudulent emails and to such a system.

With the immense increase in digital communication, especially email communication, as well as the accompanying increase in threats such as cyberattacks and phishing attempts, the protection of email communication has become an urgent necessity.

So-called email filters are known in this regard. An email filter is software or a service used to automatically sort, analyze, and/or manage incoming emails (e.g., from the internet) or outgoing emails (e.g., to the internet) based on predefined criteria. Functionally speaking, email filters are usually positioned between (company) firewalls and (company) internal computer networks, and “filter” the emails there.

Email filters are primarily used to block unwanted emails (spam), to check the content of emails, or to forward certain messages to specific folders.

There are different types of email filters—distinguished by different functions and criteria. For instance:

Spam filters prevent unwanted emails (spam) from reaching the inbox.

Spam filters analyze various characteristics of an email, such as the sender, the subject, the key words in the text, the use of certain links, or the frequency of attachments. If an email is classified as suspicious, it either ends up in the spam folder or is deleted immediately.

Content filters check the content of emails for specific keywords or phrases.

Content filters search for specific words or phrases in the email and can block or forward messages based on this content. They are useful for protecting against phishing attempts or emails with dangerous attachments.

Rule-based filtering/Rule-based filters organize emails according to specific rules or conditions.

With rule-based filters, users can define their own rules, such as forwarding emails from specific senders to a special folder, marking messages with specific words in the subject line, or deleting messages with specific attachments.

Blacklist and whitelist filters manage trusted or blocked senders.

A whitelist contains a list of trusted email addresses or domains whose messages will always be delivered. A blacklist contains senders or domains whose emails are blocked or treated as spam.

Phishing filters identify phishing emails that attempt to steal sensitive information.

Phishing filters analyze the content and origin of emails for suspicious features, such as fake sender addresses, fake links, or requests to enter personal data.

Email filters, therefore, are an important part of email communication because they help protect users from unwanted and harmful content, as well as the resulting threats and potentially immense damage. They contribute to improving efficiency and security in email communication.

However, conventional methods used by known email filters to detect suspicious emails often come up against their limitations, as they are unable to effectively detect subtle manipulations or new attack patterns.

### SUMMARY OF THE INVENTION

It is accordingly an object of the invention to provide a method which overcomes the above-mentioned and other disadvantages of the heretofore-known devices and methods of this general type and which provides for a method which is capable of reliably, easily, and effectively detecting potentially harmful or fraudulent emails.

With the above and other objects in view there is provided, in accordance with the invention, a method for protecting against potentially harmful or fraudulent emails, the method comprising:
upon receiving an incoming email, checking the incoming email to a recipient to see whether the incoming email is a reply to an outgoing email that was previously sent from the recipient of the incoming email;
when the incoming email is classified as a reply email, comparing a recipient of the outgoing email with a sender of the incoming email; and
when the incoming email is not classified as a reply email, subjecting the sender of the incoming email to an inventory audit.

In other words, the objects of the invention are achieved by a novel method for protecting against potentially harmful or fraudulent emails and by such a system for protecting against potentially harmful or fraudulent emails.

In particular, the potentially harmful or fraudulent email could be an email sent by an unauthorized third party that was generated by the unauthorized third party from an email not addressed to them but intercepted by them, as a reply email with potentially harmful content, and sent back to the original sender.

Any terms used in this specification, unless explicitly defined otherwise, should be interpreted as they would be understood within the pertinent field of technology. In particular, terms from data processing/IT are to be understood according to the conventional understanding of ordinary artisans and expert specialists in the field.

The method for protecting against potentially harmful or fraudulent emails involves checking whether an incoming email is a reply to an email that was previously sent by the recipient of the incoming email.

It is particularly expedient if this check to determine whether the incoming email is a reply to an email that was previously sent by the recipient of the incoming email is carried out using a subject line and/or a sender or recipient and/or an email thread and/or email history of the incoming email.

Such information can be detected in the incoming email using image recognition tools (or other digital methods, such as AI) and analyzed accordingly. The analysis itself, in particular determining whether it is a reply email, can also be performed using AI.

This is usually also simplified by the fact that such information, in mostly defined formats and/or with defined content, can be found at predetermined positions in the incoming email.

Emails, more particularly their headers, usually contain subject lines that reflect the subject of the email. In the case of a reply email, a specific prefix, such as “RE:” is usually placed before the subject. This indicates, for example, that the email is a reply (“RE:”) to a previously sent email.

Furthermore, the email history, i.e., the previously sent email and its content (including the header/header information at the time), is usually also displayed farther down in the incoming email. The email itself, its content, and the subject lines therein can help verify that the incoming email is a reply email.

If the incoming email is then classified as a reply email, the recipient of the previously sent email and the sender of the incoming email can be compared to ultimately ensure the authenticity of the email.

Otherwise, i.e., if the incoming email was not classified as a reply email, the sender of the incoming email may be subjected to an inventory audit (see details below).

Furthermore, if a discrepancy is detected when comparing the recipient of the sent email and the sender of the incoming email (in the case of an incoming email classified as a reply email), a notification action may be taken, for example a visual or acoustic warning issued, particularly reporting a potentially harmful or fraudulent email.

Furthermore, it can also be advantageous if such notification actions or warnings are user-defined and/or customized. It is also possible to issue notifications or warnings in stages. For example, users can adjust the sensitivity of notification actions/warnings based on their individual preferences and risk tolerance. This increases the user-friendliness and (customized) adaptability of the method.

Such a discrepancy (when comparing the recipient of the sent email and the sender of the incoming email (in the case of an incoming email classified as a reply email)) may consist, for example, of one or more altered or added letters or an altered sequence of letters or a phonetically similar sequence of letters. In particular, small and/or difficult-to-detect discrepancies may indicate a “fake” or potentially threatening email.

Otherwise, i.e., if no discrepancy is found when comparing the recipient of the sent email and the sender of the incoming email (in the case of an incoming email classified as a reply email), the incoming email can be classified as authentic, in particular as an authentic reply email.

It is expedient during inventory audits (in the case of an incoming email classified as a non-reply email) to compare the sender of the incoming email with other email addressees known to or already on file with the recipient.

Typically, the recipient maintains an “address book” (or similar directories) in which addresses previously used with or known to the recipient (of recipients) are stored.

If a discrepancy is detected during the inventory audit (between the sender of the incoming email and one or more other email addressees known to or known to exist by the recipient), a notification action can be carried out, for example by issuing a visual or acoustic warning.

Otherwise, i.e., if no discrepancy is found during the inventory audit—i.e., to put it simply, if the sender of the incoming email is known to the recipient—the incoming email can be classified as authentic.

If a discrepancy is found during the comparison in the inventory audit, a degree of discrepancy and/or similarity can be determined in particular.

Depending on the degree of discrepancy and/or similarity, a further, coordinated, specific warning action can be carried out, for example by issuing a specific visual or acoustic warning.

Furthermore, a provision can be made, for example, that if the degree of discrepancy and/or similarity is indicative of a small discrepancy and/or a large similarity, a warning is issued regarding a potentially harmful or fraudulent email. In particular, small—and therefore difficult-to-detect—discrepancies or large similarities may indicate a “fake” or potentially threatening email.

If the degree of discrepancy and/or similarity is indicative of a large discrepancy and/or little to no similarity, notice of a potential new email contact can be given. In simpler terms, the sender of the incoming email is unknown to the recipient; it is a new contact.

When making comparisons, it may also be helpful if previously sent emails from the recipient of the incoming email are stored—in a memory, for example—at the recipient's location and are thus available for analysis or comparison (see above).

It is expedient particularly if (re-)checks, comparisons, and/or classifications as well as the generation of notifications, notification actions, and/or warnings are carried out in the method (or system) using AI or learning methods, such as neural networks and decision trees. In short, the method could be AI-based. The term “AI” stands for “artificial intelligence.”

Such learning methods, or rather AI, already exhibit such a high level of development that, in particular, the (re-)checks, comparisons and/or classifications, as well as the generation of notifications, notification actions, and/or warnings using such methods, have a high degree of reliability, efficiency, and effectiveness.

AI-based—the method could continuously learn and improve its algorithms, particularly by collecting and integrating user feedback, false positives, and false negatives. For example, if users indicate that an email was incorrectly classified as harmful or safe, the system could use this information to improve future classifications.

In other words, it is advantageous particularly here if the AI or the learning process includes a function that is also based on user feedback in order to continuously improve the detection rate of harmful emails—and also to minimize false alarms.

Furthermore, this enables the method (and the system) to adapt to new threats and continuously learn from experience, making it increasingly effective.

Given the countless number of emails, training data is readily available and can thus ensure reliable AI.

Furthermore, it may be expedient if, in addition, it performs a check of the content of the incoming email for known malware signatures.

Furthermore, it is also expedient to conduct a behavioral analysis of the sender of the incoming email in order to recognize the sender's typical communication pattern and to identify deviations that might indicate a potentially suspicious email address. Communication patterns can be analyzed not only within email but also across other digital communication channels, such as social media and other messaging apps, to create more comprehensive threat profiles.

For example, it can be detected if a sender who normally sends short emails suddenly sends an unusually long message. This analysis can be particularly helpful in identifying potentially compromised email accounts. It increases the ability to identify complex and coordinated attacks.

Regardless, sentiment analysis techniques can also be applied (in addition or as the sole protective mechanism) to email content, i.e., to content from incoming emails, in order to detect subtle signs of fraud or deception that are not caught by regular filters. This technique analyzes the emotional content of (incoming) email messages to detect anomalies or suspicious patterns that may indicate phishing or deception. It can help detect subtle social engineering attacks that are not caught by regular keyword-based filters.

It is also advantageous to additionally check incoming emails for unusual behavior, such as unusually frequent sending of messages or unusually large file attachments.

Furthermore, a risk analysis can also be carried out with regard to the incoming email and/or its sender. This can include various factors in the evaluation of the email, such as the sender's domain reputation, the IP address, and the geographical origin of the email. These factors can be combined to generate a risk score that helps to better assess the hazardousness of the incoming email.

Furthermore, it may be expedient to store the incoming email separately, particularly in a quarantine area, especially if an incoming email triggers a notification, an action, and/or a warning or if an incoming email is classified as inauthentic (i.e., the email is a potentially threatening email). Deleting such an email might also be expedient.

If such an email is stored separately (which ensures that such an email does not yet enter the computer network), it can be subjected to a more detailed, customized “manual” examination (cf. similarly spam/spam filter, spam folder (see above)).

It appears to be particularly advantageous if the method (or the system)-for incoming emails-is located between a (company) firewall and a (company-)internal network.

In other words, the network (e.g., of a company) is first protected from the outside, for example vis-à-vis the internet, by a firewall. If this incoming email is not blocked—and forwarded—the method (or system) proceeds similarly to a second stage of a multi-stage (threat) protection. (The firewall could thus be understood as representing the first stage of threat protection.) Only once the incoming email has passed through both stages can it be allowed into the internal computer network.

Security can be further enhanced by implementing blockchain-based verification for emails or incoming emails to ensure the authenticity of senders and prevent manipulation. This means that blockchain technology can be used to verify the integrity and authenticity of email senders. Every email transaction could be recorded in an immutable, decentralized database. This reduces the risk of manipulation and spoofing attacks considerably.

Another layer of security can be implemented, for example, by introducing multifactor authentication for suspicious emails that require additional confirmation from the sender.

Furthermore, a provision can also be made that threat data from global security networks is obtained in real time in order to detect emerging threats at an early stage. In particular, this makes proactive detection and response to emerging threats possible.

It may also be expedient to carry out a risk assessment of incoming emails, for example by assigning a risk assessment score. This means that a score is developed that assesses the danger of incoming emails based on factors such as sender reputation, content analysis, and historical data. An algorithmically determined score assesses the danger of an (incoming) email based on various factors, such as sender reputation, content analysis, and historical data. It offers a quantified assessment of the risk of making informed decisions.

The system for protecting against potentially harmful or fraudulent emails is designed to carry out the method and refinements thereof.

It proves expedient if the system is scalable and can adapt to growing user requirements, especially in large organizations with high email volumes.

Furthermore, it may be expedient for the system to also have functions to check the content of incoming emails for known malware signatures and/or unusual behaviors, such as unusually frequent sending of messages or unusually large file attachments.

In order to ensure seamless implementation and greater adaptability to different IT infrastructures, integration with existing security solutions and email services is also possible. In particular, the system could provide API interfaces to seamlessly integrate with existing email services and security solutions, which would facilitate implementation and increase user acceptance.

Furthermore, it may also be possible to implement an additional authentication layer by requiring senders to verify themselves through a second communication channel for suspicious emails before the email is classified as authentic. This could, for example, include multifactor authentication, in which incoming emails or senders identified as suspicious are asked to confirm their identity through a second communication channel (such as SMS confirmation) before the email is considered secure. This increases security particularly by making it more difficult for attackers to use fake identities.

It is also advantageous if the system offers a user-friendly interface that allows users to provide feedback in order to further optimize the process or the algorithms used there for detecting phishing and fraud. An intuitive interface can help users interact more easily with the system, provide feedback, and improve recognition algorithms. Through feedback loops, users could inform the system about false positive or false negative identifications, which in turn increases the accuracy of the system.

It appears to be particularly expedient if the system is implemented using software that is provided especially as a server installation, as cloud software, or as application software.

A mobile application can also be expedient for monitoring and managing email security while on the go. It increases flexibility and responsiveness, especially for users who frequently work remotely.

Pilot projects with selected industries can be carried out to test and validate the effectiveness of the system in real-world scenarios.

Real-time capability in the system and the method may also be advantageous. This means that the system or method is able to analyze incoming emails in real time and immediately warn users in order to minimize delays in the workflow. That is, the ability to analyze emails in real time can be crucial in quickly warning users and thus preventing potential damage or data loss. This could be achieved through the use of fast data processing and analysis solutions.

In particular, this makes it possible to use (dynamic) user dashboards, which provide users with real-time statistics on detected threats, email traffic, and system activity. An interactive dashboard can thus provide a real-time overview of security alerts, system status, and threat statistics. Users gain a clear overview and are able react more quickly to potential threats.

Furthermore, it may also be important that the system satisfy compliance and data protection regulations, such as the GDPR, for example by minimizing and making transparent the processing of personal data. This avoids legal problems and strengthens users'trust in the system.

Furthermore, partnerships with established security providers can be considered in order to strengthen the reach and implementation of the system.

The invention specifically addresses the growing threat of cyberattacks and offers a robust, proactive approach to securing email communication. It responds to modern threats and technological advances, thus improving more comprehensive protection against harmful or fraudulent emails.

It is especially valuable for companies and organizations that handle sensitive information on a daily basis and the protection of which is of the highest priority. Furthermore, AI-based technology opens up the possibility of adapting to new threats and continuously learning from experience—thereby improving the detection rate for harmful or fraudulent emails.

The description of advantageous embodiments of the invention given thus far contains numerous features, some of which are summarized in the individual subclaims. However, these features can also be considered individually and combined into meaningful further combinations.

Even if some terms are used in the singular or in conjunction with a numeral in the description or in the patent claims, the scope of the invention for these terms should not be limited to the singular or to the respective numeral. Furthermore, the words “a” and “an” are not to be understood as numerals, but as indefinite articles.

Other features which are considered as characteristic for the invention are set forth in the appended claims. It will be understood that the description of the invention relates to both the method and the system.

The properties, features, and advantages of the invention described above, as well as the manner in which these are achieved, become clearer and more easily understood in connection with the following description of the embodiments of the invention, which are explained in greater detail in connection with the drawings/figures (identical parts/components and functions have the same reference symbols in the drawings/figures).

The exemplary embodiments serve to illustrate the invention and do not limit the invention to combinations of features specified therein, including with regard to functional features. Furthermore, suitable features of each exemplary embodiment can also be explicitly considered in isolation, taken from one exemplary embodiment, incorporated into another exemplary embodiment to supplement it, and combined with any one of the claims.

### BRIEF DESCRIPTION OF THE FIGURES

FIG. 1 shows a representation illustrating a system for information security or cyber protection in email communication according to an exemplary embodiment of the invention;

FIG. 2 shows an (incoming) email according to one embodiment; and

FIG. 3 shows a security structure for an email filter in a (computer) network of a company/firm according to one embodiment of the invention.

### DETAILED DESCRIPTION OF THE INVENTION

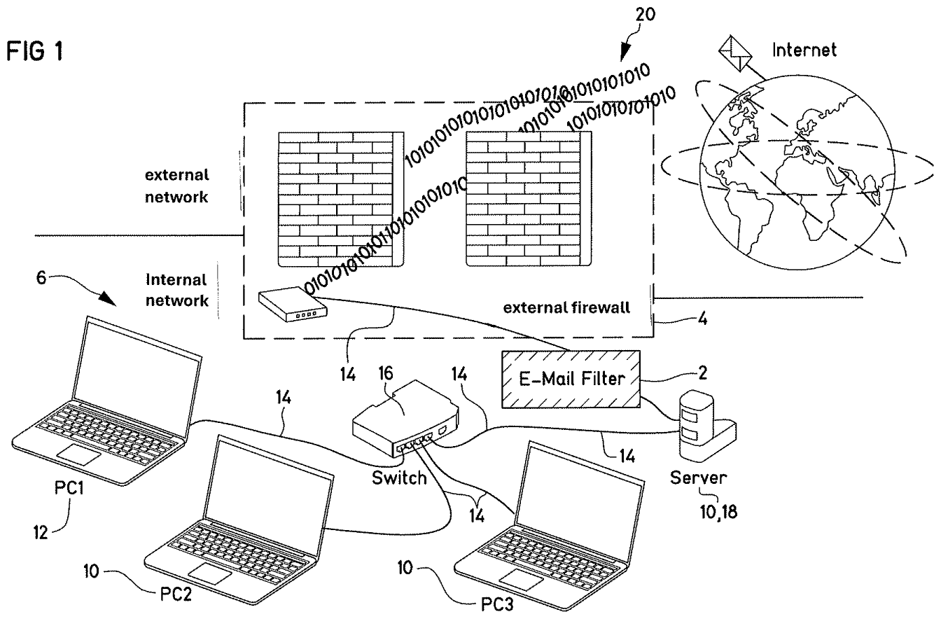

### Information Security and Cyber Protection in Email Communication for a (Company) Computer Network (FIGS. 1 and 2, and FIG. 3)

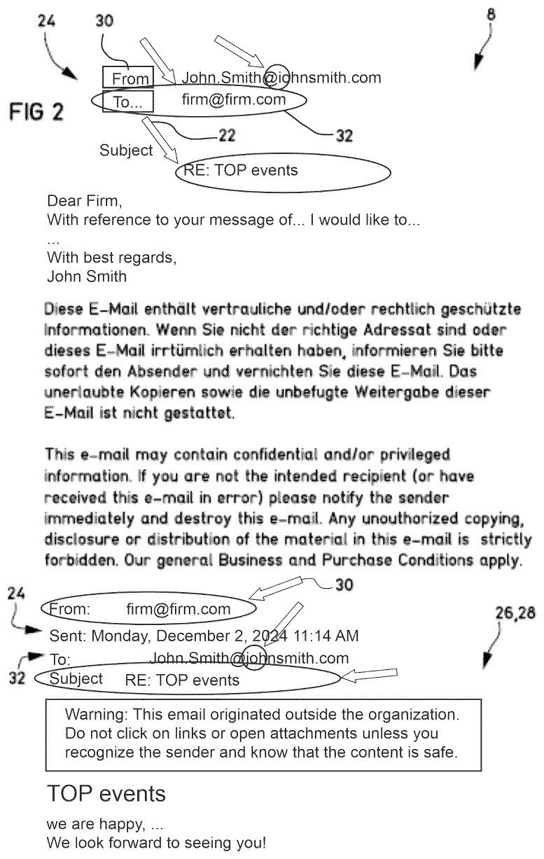

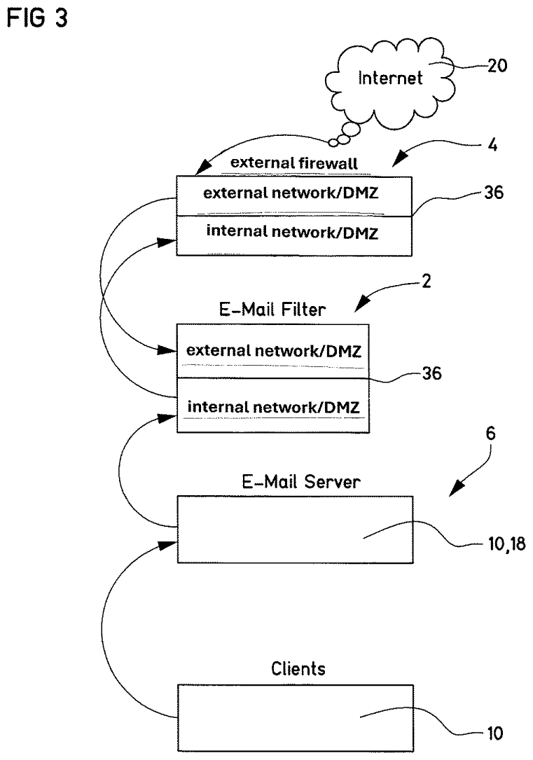

FIG. 1 illustrates a system for information security or cyber protection in email communication within an internal (computer) network 6 of a company/firm secured with a firewall 4 and an email filter 2. FIG. 2 shows an email 8 entering the company network 6 and analyzed by the email filter 2. FIG. 3 shows an alternative security structure/architecture for the email filter 2 in the (computer) network 6 of the company/firm.

FIG. 1 illustrates (in its lower portion) a typical company (computer) network, or LAN 6, with common devices such as PCs/computers 10, printers 12, etc. (referred to as nodes) which are connected by cables 14 via switches 16 (=device with many network ports which can forward data to the devices connected within a network). It should be clear, of course, that WLAN wireless connections may also be used instead of the cables 14.

One of the computers 10 acts as a server 18—and provides special services (in the LAN) (referred to as “server programs”), such as storing files for the other computers or a mail system (email server).

An (external) firewall 4 restricts network access from the internet (external network; WAN) 20 to the computer network 6. The firewall 4 does this (in technical terms) by, for example, allowing (reply) packets requested from within the internal network 6 and blocking all other network packets.

As a further safeguard, an email filter 2 is provided—functionally located between the firewall 4 and the computer network 6—which automatically sorts, analyzes, and/or manages emails 20 coming from or going to the internet based on defined criteria.

In addition to familiar filter functions (see above, e.g., spam filter), the email filter 2 also provides a special filter (cyber protection) which checks incoming emails 8 for potentially threatening emails—according to a special method for protecting against potentially harmful or fraudulent emails, or simply the “method.”

Particularly where the email filter 2 performs cyber protection, i.e., in the method where the email filter 2 is AI-based. In other words, AI-based algorithms or learning methods are used particularly where the email filter or the method performs (re-)checks, comparisons, and/or classifications, as well as generating notifications, notification actions, and/or warnings.

### Email Filter

In the email filter 2, or in the method, an incoming email 8 at the computer network 6 or server 18 (not blocked by the firewall 4) is first checked to see whether the incoming email 8 is a reply email to an email that was previously sent by or from the computer network 6.

This check to determine whether the incoming email 2 is a reply email is carried out, as is particularly illustrated in FIG. 2, using a subject line, or subject 22, in the incoming email 8.

The email filter 2 or the method analyzes the subject 22 in the header 24 of the incoming email 2, here: “RE: TOP events.”

The email filter 2 or the method recognizes the prefix “RE:” in the subject 22 during its analysis, which signals/indicates that it is a reply/reply email to a previously sent email with the previous/original subject 22 “TOP events.”

Furthermore, in order to increase the redundancy of the result or to verify it further, the email filter 2 or the method then also analyzes the entire content of the incoming email 8 itself.

Here, the email filter 2 or the method searches in the incoming email 8 for an email thread or email history 26, which is listed or continues to be listed in the incoming email 8 following the original content of the incoming email 8 (see FIG. 2).

It is there that the email filter 2 or the method recognizes the previously sent/original email 28 (and its header 24) where the original subject 22 “TOP events” can be found.

The previous subject 22 “TOP events” in the previous email 28 and the current subject 22 “Re: TOP events” in the incoming email 8 indicate that incoming email 8 is a reply email (regarding “TOP events”) to the original email 28.

The email filter 2 classifies the incoming email 8 as a reply email.

The same conclusion could also be drawn from the former the sender

30, firm@firm.com, the original email 28, and the current recipient 32, firm@firm.com, of the incoming email 8.

However, whether this (now thusly classified) reply email actually originates from the original recipient is now checked by the email filter 2, as it could be an email sent by an unauthorized third party that was generated (and sent back) by them from the original email 28, which was not addressed to them but intercepted by them, as a reply email with potentially harmful content.

For this purpose, the email filter 2 or the method compares the recipient 32 of the previously/originally sent, original email 28, “John.Smith@johnsmith.com,” and the sender 30 of the incoming email 8, “John.Smith@iohnsmith.com.”

FIG. 2 illustrates this comparison, which is taken directly from the incoming email 8. The email filter 2 or the method searches on the one hand in the header 24 of the incoming email 8 for the sender 30, “John.Smith@iohnsmith.com,” and on the other hand in the header 24 of the originally sent email 28 (in the email history/email flow 26) for the recipient 32, “John.Smith@johnsmith.com.”

Alternatively, this could also be done using a backup copy of the original, initially sent email stored in the computer network 6, from which the recipient (here: “John.Smith@johnsmith.com”) would be determined. As before, the sender would still have to be determined from the received email (here: “John.Smith@iohnsmith.com”)

If a discrepancy is detected during the comparison, as here (see FIG. 2), namely an altered letter, “i” in “John.Smith@iohnsmith.com” instead of a “j” in “John.Smith@johnsmith.com,” a notification action is taken, for example by issuing a visual or acoustic warning, such as a warning about a potentially harmful or fraudulent email.

If the email filter 2 or the method were to detect no discrepancy between sender 30 and recipient 32, the incoming email 8 would be classified as authentic, in particular as an authentic reply email.

In the event that the email filter 2 or the method did not classify the incoming email 8 as a reply email, the email filter 2 or the method performs an inventory audit on the incoming email 8.

In this inventory audit, the email filter 2 or the method compares the sender 30 of the incoming email 8, here “John.Smith@iohn.smith.com,” with other email addressees known or known to exist in the computer network 6.

For this purpose, the email filter 2 accesses an “address book”maintained in the computer network 6, in which previously known (external) addresses (of external recipients) are stored.

If, during the inventory audit, no matching or similar recipient is found in the address book, the email filter 2 or the method classifies the incoming email 8 as a new email contact and marks the incoming email 8 with a warning message, e.g., “Warning: This is an email from a previously unknown sender. Please check the sender. In particular, do not click on links or open attachments unless you recognize the sender and/or know that the content is safe.”

If an identical recipient is found in the address book, the email filter 2 or the method classifies the incoming email 8 as authentic (from an already known email contact) and allows the incoming email 8 into the computer network 6.

If the email filter 2 or the method during the inventory audit of the incoming email 8 detects a certain similarity or a certain degree of similarity (or degree of discrepancy), for example a high degree of similarity (or a low degree of discrepancy), such as (only) a different letter (see above, e.g. “i” in “John.Smith@iohnsmith.com” instead of a “j” in “John.Smith@johnsmith.com”), a warning is issued indicating a potentially harmful or fraudulent email.

If the degree of discrepancy and/or similarity is indicative of a large discrepancy and/or little to no similarity, this could—assuming a previously unknown email contact—again indicate a potentially new email contact, e.g., “Warning: This is an email from a previously unknown sender. Please check the sender. In particular, do not click on links or open attachments unless you recognize the sender and/or know that the content is safe.”

### Alternative Security Structure/Architecture for the Email Filter

FIG. 3 shows an alternative security structure/architecture 34 for the email filter 2 on the computer network 6.

As FIG. 3 illustrates, the security structure 34 provides for a DMZ 36, with a firewall concept. In this case, a firewall 4 separates the internet 20 from the DMZ 36. The email filter 2 is located in the DMZ 36.

Although the invention has been illustrated and described in greater detail by the preferred exemplary embodiments, the invention is not restricted by the disclosed examples and other variations may be derived from them without departing from the scope of protection of the invention.

The following is a summary list of reference numerals and the corresponding structure used in the above description of the invention:
2 email filter
4 firewall
6 (internal) (company/corporate) computer network/network
8 (incoming) email
10 PC, computer
12 printer
14 cable
16 switch
18 server
20 internet, external network, WAN
22 subject information/line (“Subject”), Subject
24 header
26 email history
28 previously sent/original email
30 sender (“From”)
32 addressee (“To”)
34 security structure/architecture
36 DMZ

1. A method for protecting against potentially harmful or fraudulent emails, the method comprising:
upon receiving an incoming email, checking the incoming email to a recipient to see whether the incoming email is a reply to an outgoing email that was previously sent from the recipient of the incoming email;
when the incoming email is classified as a reply email, comparing a recipient of the outgoing email with a sender of the incoming email; and
when the incoming email is not classified as a reply email, subjecting the sender of the incoming email to an inventory audit.

2. The method according to claim 1, which comprises, when the incoming email is classified as a reply email:
when a discrepancy is detected in comparing the recipient of the outgoing email with the sender of the incoming email, taking a notification action to report a potentially harmful or fraudulent email; or
when no discrepancy is found in comparing the recipient of the outgoing email with the sender of the incoming email, classifying the incoming email as an authentic reply email.

3. The method according to claim 1, wherein taking the notification action comprises issuing a visual or acoustic warning.

4. The method according to claim 1, wherein the inventory audit, which is triggered when the incoming email is classified as a non-reply email, comprises comparing the sender of the incoming email with other email addressees that are known to, or on file with, the recipient.

5. The method according to claim 1, which comprises:
when a discrepancy is detected during the inventory audit, carrying out a notification action by issuing a visual or acoustic warning; or
when no discrepancy is found during the inventory audit, classifying the incoming email as authentic.

6. The method according to claim 4, which comprises:
when a discrepancy is found during a comparison in the inventory audit, determining at least one of a degree of discrepancy or a degree of similarity; and
depending on the degree of discrepancy or the degree of similarity, issuing a specific visual or acoustic warning.

7. The method according to claim 6, wherein:
when the degree of discrepancy or the degree of similarity is indicative of a small discrepancy or a large similarity, respectively, assuming that the email is a potentially harmful or fraudulent email; or,
when the degree of discrepancy or the degree of similarity is indicative of a large discrepancy or a small or no similarity, respectively, assuming that the sender is potentially a new email contact.

8. The method according to claim 1, which comprises carrying out checks, rechecks, comparisons, classifications, and warnings by using artificial intelligence (AI).

9. The method according to claim 1, which comprises:
when an incoming email triggers at least one of a notification, a notification action, or a warning, or when an incoming email is classified as being inauthentic, deleting the incoming email or separately archiving the email in a quarantine area.

10. The method according to claim 1, which comprises checking the incoming email as to whether the incoming email is a reply to an outgoing email by using at least one of a subject line, a sender or recipient, or an email thread, or an email history of the incoming email.

11. The method according to claim 1, which comprises carrying out the method steps for incoming emails between a firewall and an internal network.

12. The method according to claim 1, which comprises additionally checking a content of the incoming email for known malware signatures.

13. The method according to claim 1, which comprises additionally checking the incoming emails for unusual behavior.

14. The method according to claim 13, wherein the unusual behavior is unusually frequent sending of messages or unusually large file attachments.

15. A system for protecting against potentially harmful or fraudulent emails, comprising a processor configured to carry out the method according to claim 1.

16. The system according to claim 15, which comprises functions for checking a content of incoming emails for known malware signatures and/or unusual behavior.

17. The system according to claim 15 implemented with software that is provided as a server installation, as cloud software, or as application software.
